(19) United States
(12) Patent Application Publication
(10) Pub. No.: US 2006/0014428 A1
(43) Pub. Date: Jan. 19, 2006

(54) Electrical connecting device

(75) Inventor: Tsuyoshi Osada, Nishikamo-gun (JP)

Correspondence Address: OSHA LIANG L.L.P., 1221 MCKINNEY STREET, SUITE 2800, HOUSTON, TX, 77010, US

(73) Assignee: J.S.T. Mfg. Co., Ltd., Osaka (JP)

(21) Appl. No.: 11/166,045

(22) Filed: Jun. 24, 2005

(30) Foreign Application Priority Data
Jun. 25, 2004 (JP) 2004-187336

(51) Int. Cl. H01R 9/05

(52) U.S. Cl. 439/582

(57) ABSTRACT

A terminal connection part 14 that is connected to a to-be-connected terminal, a wire connection part 15 on a side opposite the terminal connection part 14, and a bent part 16 between the terminal connection part 14 and the wire connection part 15 are provided to each of the connection terminals 11 of four or more poles. A connecting housing element 12 has a terminal supporting part 22 that supports each connection terminal 11 so that the terminal connection parts 15 are arranged in a parallel manner in rectilinear form and are connected to the to-be-connected terminals. The connecting housing element 12 additionally has a wire supporting part 19 that supports the electric wires 3 so that the electric wires 3 are led out in a direction parallel to the linear arrangement direction of the terminal connection parts 14. The wire supporting part 19 supports the electric wires 3 so that the electric wires 3 connected to the front-side connection terminals 11 are arranged in such a curved manner as to detour the periphery of the leading-side connection terminals 11. The connecting housing element 12 is connected to the to-be-connected housing element 2 by being fitted therewith.

### TECHNICAL FIELD

The present invention relates to an electrical connecting device that is connected to a to-be-connected housing element, which supports to-be-connected terminals of four or more poles which are arranged in a parallel manner in rectilinear form.

### BACKGROUND ART

An electrical connecting device that is connected to a to-be-connected housing element, which supports to-be-connected terminals of four or more poles which are arranged in a parallel manner in rectilinear form has been conventionally known. Japanese Published Unexamined Patent Application No. H11-251002, for example, discloses a coaxial connector having a number of cores which is formed of a plug coupling part and a receptacle coupling part as a connector that includes the above-described electrical connecting device. In this coaxial connector, the plug coupling part is provided with four poles of the first central contacts and the first external contacts, and these four pole contacts are arranged in a parallel manner in rectilinear form. On the other hand, in the receptacle coupling part, four pole second central contacts and second external contacts which are respectively electrically connected to the four pole contacts on the plug coupling part side are arranged in a parallel manner in rectilinear form, at points which respectively correspond to the four pole contacts on the plug coupling part side. Thus, four coaxial cables which correspond to and are connected to the respective contacts lead out in a straight line on the side opposite the side where the four pole contacts on either side, the plug coupling part side or the receptacle coupling part side, are respectively connected in the arrangement.

In the coaxial connector that is described in Japanese Published Unexamined Patent Application No. H11-251002, however, the coaxial cable that leads out from either housing element on the plug coupling part side or the receptacle coupling part side is arranged so as to lead out in a straight line in the direction perpendicular to the direction in which each housing element is aligned in a parallel manner. Therefore, in either housing element, the size of the housing element may become too large, depending on the pitch between the poles which are arranged in a parallel manner.

Accordingly, there is some spatial restriction, due to the size of the housing elements when each connector is worked on so as to be connected. That is, it brings disadvantages when working on a connection within a limited space or through such a space, like work in a narrow space.

This is extremely disadvantageous particularly in the case where a to-be-connected housing element that supports to-be-connected terminals of four or more poles which are arranged in a parallel manner in a rectilinear form, and an electrical connecting device having a connecting housing element, that supports connection terminals of four or more poles which are electrically connected to the to-be-connected terminals, respectively, are connected to each other after this electrical connecting device has been inserted into a hole formed in a wall. That is, the size of the electrical connecting device that is inserted into a hole formed in a wall restricts the size of this hole, or makes the insertion work of the electrical connecting device difficult.

### DISCLOSURE OF THE INVENTION

In view of the above-described situation, an object of the present invention is to provide a compact electrical connecting device that can reduce the disadvantage of the dimensional restriction in the case where a to-be-connected housing element that supports to-be-connected terminals of four or more poles which are arranged in a parallel manner in rectilinear form and an electrical connecting device having a connecting housing element that supports connection terminals of four or more poles which are electrically connected to the to-be-connected terminals, respectively, are connected to each other.

The present invention relates to an electrical connecting device that is connected to a to-be-connected housing element that supports to-be-connected terminals of four or more poles which are arranged in a parallel manner in rectilinear form.

Thus, the present invention is characterized by several points, as described below, in order to achieve the above-described object. That is, the present invention has any of the below described features, either by themselves or in an appropriate combination.

A first feature of the electrical connecting device of the present invention to achieve the object is that the electrical connecting device comprises connection terminals of four or more poles that are electrically connected to the to-be-connected terminals of four or more poles, respectively, and a connecting housing element that fits to connect to the to-be-connected housing element, each of the connection terminals having a terminal connection part that is connected to the to-be-connected terminal; a wire connection part that is an end on a side opposite the terminal connection part and that is connected to an electric wire; and a bent part bent between the terminal connection part and the wire connection part, the connecting housing element having a terminal supporting part that supports each of the connection terminals so that the terminal connection parts are arranged in a parallel manner in rectilinear form and are connected to the to-be-connected terminals, respectively; and a wire supporting part that supports each of the electric wires so that the electric wires connected to the wire connection parts are led out in a direction parallel to a linear arrangement direction in which the terminal connection parts are arranged, wherein the wire supporting part supports the electric wire so that the electric wire connected to a front-side connection terminal, which is one of the connection terminals adjacent to each other, disposed on an extreme side (front side) opposite a wire leading side where the electric wire is led out from the connecting housing element can be arranged in such a curved manner as to detour the periphery of the bent part of the leading-side connection terminal that is the connection terminal adjacent to the front-side connection terminal on the wire leading side.

According to this configuration, the connection terminal has the bend part between the terminal connection part and the wire connection part, and the electric wire connected to the wire connection part is led out in the direction parallel to the linear arrangement direction in which the terminal connection part is arranged. The electric wire connected to the front-side connection terminal is arranged in such a curved manner as to detour the periphery of the bent part of the leading-side connection terminal. Therefore, the electric wires can be bundled in the parallel direction, and can be efficiently gathered without interference with the leading-side connection terminals, and hence a space to arrange the electric wires can be concentrated. In other words, great controls can be imposed on the fact that the electrical connecting device becomes large depending on the pitch where the terminal connection parts are arranged in parallel, and, accordingly, the electrical connecting device can be reduced in size. This is advantageous in performing operations in a limited space like a narrow space or in performing a connecting operation through such a space. Since the electrical connecting device is slender in the linear direction in which the terminal connection parts are arranged, a great advantage can be obtained especially when a hole formed in the wall surface is connected to another member after the electrical connecting device is passed therethrough. In other words, the size of the hole can be reduced, and the electrical connecting device can be easily passed therethrough.

Additionally, since the electric wires can be efficiently gathered without interference between the electric wires connected to the front-side connection terminals and the leading-side connection terminals, it is possible to ease dimensional restrictions on the arrangement of the front-side connection terminals and the leading-side connection terminals that adjoin each other. That is, since an interval between the front-side connection terminal and the leading-side connection terminal can be shortened, it is possible to achieve a size reduction in the longitudinal direction, and it is possible to increase the design freedom of the wire connection part of the front-side connection terminal, and it is possible to ease the fact that the electric wire connected to the wire connection part of the front-side connection terminal is bent.

Therefore, it is possible to provide a small-sized electrical connecting device that can ease a disadvantage resulting from dimensional restrictions on a connection between the to-be-connected housing element that supports the to-be-connected terminals of four or more poles arranged in a parallel manner in rectilinear form and the electrical connecting device that has the connecting housing element supporting the connection terminals of four or more poles that are electrically connected to the to-be-connected terminals, respectively.

A second feature of the electrical connecting device of the present invention is that the bent part is bent at a right angle.

According to this configuration, it is possible to diminish the distance between the straight line along which the terminal connection part is arranged in a parallel manner and the electric wire that is connected to the wire connection part and that is arranged in parallel with the straight line. That is, a slenderer shape extending in the direction in which the terminal connection part is arranged can be formed, and the electrical connecting device can be made more compact.

A third feature of the electrical connecting device of the present invention is that the terminal supporting part supports the front-side connection terminal so that an orientation direction of the wire connection part of the front-side connection terminal deviates obliquely from the linear arrangement direction of the terminal connection part.

According to this configuration, since the orientation direction of the wire connection part is deviated obliquely from the linear arrangement direction of the terminal connection part, a space in the width direction inside the electrical connecting device can be effectively utilized, and the electric wires can be more efficiently gathered without interference between the electric wires connected to the front-side connection terminals and the leading-side connection terminals.

A fourth feature of the electrical connecting device of the present invention is that the electric wire that is connected to at least one of the front-side connection terminals is supported to be arranged in such a curved manner as to detour the periphery of the bent part of the leading-side connection terminal while shifting a position thereof toward a non-fit side opposite a side where the electrical connecting device is fitted to the to-be-connected housing element in the connecting housing element.

According to this configuration, the electric wire connected to the front-side connection terminal is arranged in such a curved manner as to detour the periphery of the leading-side connection terminal while shifting the position thereof toward the non-fit side. Therefore, interference can be avoided between the electric wire connected to the front-side connection terminal and the leading-side connection terminal, and the electric wires can be efficiently gathered together even in a space on the non-fit side for the electric wires connected to the leading-side connection terminals. Therefore, it is possible to achieve a greater reduction of dimensional restrictions on the arrangement of the front-side connection terminal and the leading-side connection terminal that adjoin each other.

A fifth feature of the electrical connecting device of the present invention is that the wire supporting part further has a stacking supporting part that supports each electric wire so that a cross-section of a portion supported by the wire supporting part of each electric wire connected to the wire connection part is arranged in a stacked manner as an upper one toward the non-fit side, and the electric wire disposed as an upper one at the stacking supporting part is arranged in such a curved manner as to detour the periphery of the bent part of the leading-side connection terminal while shifting a position thereof toward the non-fit side.

According to this configuration, since the electric wires that are connected to the wire connection parts and that are arranged in a parallel manner can be disposed so as to stack the cross-sections thereof, the electric wires can be more densely bundled in the parallel direction. Additionally, since the upper one of the electric wires stacked thereon is disposed in such a curved manner as to detour the periphery of the leading-side connection terminal while shifting its position toward the non-fit side, the electric wires can be efficiently gathered without interference between the electric wires connected to the front-side connection terminals and the leading-side connection terminals when the upper electric wire is disposed in such a manner as to be drawn around.

A sixth feature of the electrical connecting device of the present invention is that the wire supporting part further has a curved supporting part that supports the electric wire connected to at least one of the front-side connection terminals so as to be arranged in such a curved manner as to detour the periphery of the bent part of the leading-side connection terminal while shifting a position thereof toward the non-fit side.

According to this configuration, since the curved supporting part is provided, the electric wire connected to the front-side connection terminal can be stably supported without being moved when the electric wire connected to the front-side connection terminal is disposed in such a curved manner as to detour the periphery of the leading-side connection terminal while shifting its position toward the non-fit side.

A seventh feature of the electrical connecting device of the present invention is that the curved supporting part further has a step part having a plurality of steps protruding from the connecting housing element toward the non-fit side so that the steps become higher in order toward the non-fit side.

According to this configuration, since the step part having a plurality of steps that become higher step by step is provided, the electric wire can be disposed while smoothly shifting its position toward the non-fit side. Additionally, the curved supporting part can be easily formed by a simple structure that the step part having a plurality of steps is provided.

An eighth feature of the electrical connecting device of the present invention is that the curved supporting part further has a slope part having a slant surface ascending toward the non-fit side.

According to this configuration, since the slope part having a slant surface ascending toward the non-fit side is provided, the electric wires can be arranged while smoothly shifting their positions toward the non-fit side. Additionally, the curved supporting part can be easily formed with a simple structure that the slope part is provided.

A ninth feature of the electrical connecting device of the present invention is that the curved supporting part further has a curved wall part that protrudes toward the non-fit side and that has a curved surface portion coming into contact with the electric wire.

According to this configuration, since the curved wall part is provided, the electric wire can be disposed in such a smoothly curved manner as to detour the periphery of the leading-side connection terminal while shifting its position toward the non-fit side by disposing the electric wire connected to the front-side connection terminal along the curved wall part. Additionally, the electric wire that is disposed in a curved manner can be stably supported not to be moved.

A tenth feature of the electrical connecting device of the present invention is that the wire supporting part further has a plurality of projection parts that protrude toward the non-fit side in the connecting housing element and that support the electric wire by fitting the electric wire between a pair of projection parts that face each other, and the wire supporting part further has convex parts that are formed on mutually facing surfaces of the pair of projection parts, respectively, and that protrude toward the electric wire fitted between the mutually facing surfaces.

According to this configuration, the electric wires can be supported merely by providing the projection parts on the connecting housing element and by fitting the electric wires between the pair of projection parts that face each other. Therefore the wire supporting part can be easily formed. Additionally, since the convex part is formed on each facing surface between the projection parts, the electric wire fitted between the projection parts can be stably supported by the convex part.

An eleventh feature of the electrical connecting device of the present invention is that the convex part is semicircular in cross-section.

According to this configuration, the electric wires can be supported by the mutually closest portions between the convex parts nearly in a line contact state, and the electric wires can be held with a greater force. Additionally, since the convex part is semicircular in cross-section, the electric wires can be prevented from being flawed by the convex part.

A twelfth feature of the electrical connecting device of the present invention is that the electrical connecting device further comprises a cover element that is attached to the connecting housing element so as to cover the connection terminals, in which the cover element has a cover-side engagement part inside the cover element, and the connecting housing element to which the cover element is attached has a housing-side engagement part on a side facing the inside of the cover element, and the cover-side engagement part and the housing-side engagement part are engaged with each other.

According to this configuration, the cover-side engagement part is provided inside the cover element, and the housing-side engagement part is provided on the side opposite the inside of the cover element. Therefore, when the cover-side engagement part and the housing-side engagement part are engaged with each other, and then the cover element is attached to the connecting housing element, neither the cover-side engagement part nor the housing-side engagement part can be exposed outward. Therefore, a mechanism to make an engagement between the cover element and the connecting housing element can be prevented from interfering with an external member and from being damaged.

A thirteenth feature of the electrical connecting device of the present invention is that the cover-side engagement part has an engagement protrusion part that protrudes toward the connecting housing element to which the cover element is attached inside the cover element and an engagement convex part that further protrudes from the engagement protrusion part, whereas the housing-side engagement part has a hole part that has an engagement concave part hollowed so as to be engaged with the engagement convex part and into which the engagement protrusion part is fitted.

According to this configuration, the provision of the engagement protrusion part having the engagement convex part inside the cover element and the formation of the hole part having the engagement concave part in the connecting housing element make it possible to easily form the mechanism to make an engagement between the cover element and the connecting housing element so as to have a simple structure without being exposed outward.

A fourteenth feature of the electrical connecting device of the present invention is that the electrical connecting device further comprises a cover element that is attached to the connecting housing element so as to cover the connection terminals, in which the cover element and the connecting housing element have positioning parts, respectively, for positioning by being engaged with each other at least either on the extreme side or on the wire leading side.

According to this configuration, in order to attach the cover element to the connecting housing element, the positioning parts formed either on the extreme side or on the wire leading side are first engaged with each other, and thereby the cover element and the connecting housing element can be easily positioned. Therefore, the cover element can be promptly attached without a positional disagreement between the connecting housing element and the cover element. Additionally, since positioning can be performed at once when the cover element is attached to the connecting housing element, the cover element can be prevented from being improperly attached to the connecting housing element by mistake. Additionally, the occurrence of damage or the like resulting from the incorrect attachment in a deviated position can be prevented.

A fifteenth feature of the electrical connecting device of the present invention is that the positioning part includes a first stripe part or a first groove part provided on the cover element and a second groove part that is engaged with the first stripe part or a second stripe part that is engaged with the first groove part, and the second groove part and the second stripe part are provided on the connecting housing element.

According to this configuration, since the positioning part is formed of the groove part and the stripe part that are engaged with each other, the positioning of the cover element and the connecting housing element by using the positioning part makes it possible to prevent the cover element from being attached in a state of being twisted with respect to the connecting housing element.

A sixteenth feature of the electrical connecting device of the present invention is that a front part of the cover element on the extreme side is tapered toward the extreme side, and is formed to cover the extreme side of the connecting housing element to which the cover element is attached, and, in the cover element, the first stripe part or the first groove part is formed on a first sliding surface to be covered while being slid onto the extreme side of the connecting housing element of the front part, whereas, in the connecting housing element, the second groove part or the second stripe part is formed on a second sliding surface that is slid onto the first sliding surface on the extreme side of the connecting housing element.

According to this configuration, since the extreme part of the cover element covers the extreme side of the connecting housing element and is tapered toward its tip, the cover element can be smoothly and easily inserted into a hole when the electrical connecting device is inserted into the hole and is then connected to the connecting housing element. Additionally, since the first stripe part or the first groove part is formed on the first sliding surface of the cover element and since the second groove part or the second stripe part is formed on the second sliding surface of the connecting housing element, it is possible to easily form a positioning part that can prevent the cover element from being attached in a state of being twisted with respect to the connecting housing element.

A seventeenth feature of the electrical connecting device of the present invention is that the electrical connecting device is used as an electrical connecting device that is first inserted into a hole formed to insert the electric wires between the inside and outside of a vehicle, and is then connected to the to-be-connected housing element.

According to this configuration, the electrical connecting device can be easily inserted into the hole formed to insert the electric wires between the inside and outside of a vehicle, and the size of the hole can be reduced.

The above-mentioned and other objects, features, and advantages of the present invention will become apparent by reading the following description with reference to the attached drawings.

### BRIEF DESCRIPTION OF THE DRAWINGS

FIG. 1 is a perspective view of an electrical connecting device according to an embodiment of the present invention and a to-be-connected housing element that is connected to the electrical connecting device.

FIG. 2 is a perspective view showing a state in which the electrical connecting device and the to-be-connected housing element shown in FIG. 1 are connected.

FIG. 3 is a perspective view of the electrical connecting device shown in FIG. 1.

FIGS. 4(a), 4(b), 4(c), and 4(d) area front view, a bottom view, a left side view, and a right side view of the electrical connecting device shown in FIG. 3, respectively.

FIG. 5 is an exploded perspective view of a part of the electrical connecting device shown in FIG. 3.

FIG. 6 is a perspective view of a connection terminal shown in FIG. 5.

FIG. 7 is a perspective view of a connecting housing element shown in FIG. 3.

FIG. 8 is a perspective view of the connecting housing element shown in FIG. 3.

FIG. 9 is an enlarged perspective view of a projection part of the connecting housing element shown in FIG. 8.

FIG. 10 is a perspective view of a cover element shown in FIG. 3.

FIG. 11 is a cross-sectional view along line A-A of FIG. 4.

FIG. 12 shows a state in which an assembled electrical connecting device is inserted in a roof hole used for vehicles.

### BEST MODE FOR CARRYING OUT THE INVENTION

The best mode for carrying out the present invention will be hereinafter described with reference to the drawings. Although a description is given of an electrical connecting device that is connected to a to-be-connected housing element which supports to-be-connected terminals of four poles (four pieces) according to this embodiment, the present invention is applicable in a case in which the to-be-connected housing element supports to-be-connected terminals of five or more poles. In other words, the present invention can be widely applied to an electrical connecting device that is connected to a to-be-connected housing element which supports to-be-connected terminals of four or more poles which are arranged in a parallel manner in rectilinear form.

The present invention is especially suitable for use as an electrical connecting device that is connected to a to-be-connected housing element after the electrical connecting device is inserted into a hole formed to pass an electric wire therethrough between the outside and the inside of a vehicle. This use is taken as an example and is described in this embodiment. However, the present invention can be applied even in a case in which the electrical connecting device is used other than this use, and can be more widely applied. That is, the present invention can be applied in many different environments and for various purposes.

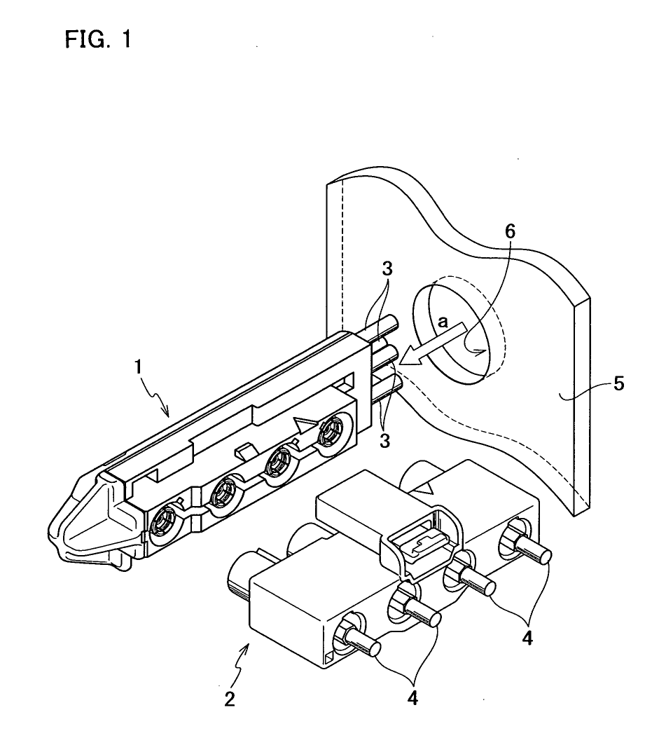

FIG. 1 is a perspective view showing a to-be-connected housing element 2 to which coaxial electric wires 4 (hereinafter, referred to simply as “electric wire(s) 4”) of four poles (four pieces) are connected and an electrical connecting device 1 according to an embodiment of the present invention that is connected to coaxial electric wires 3 (hereinafter, referred to simply as “electric wire(s) 3”) 3 of four poles (four pieces) in the same way and that is connected to the to-be-connected housing element 2. For example, the electrical connecting device 1 and the to-be-connected housing element 2 are used as relay connectors for use in various multi-receivable antennas, such as an AM/FM antenna, a Cellular antenna, a GPS (Global Positioning System) antenna, a SDARS (Satellite Digital Audio Radio System) antenna, an ETC antenna, or a VICS antenna, that are attached to a vehicle.

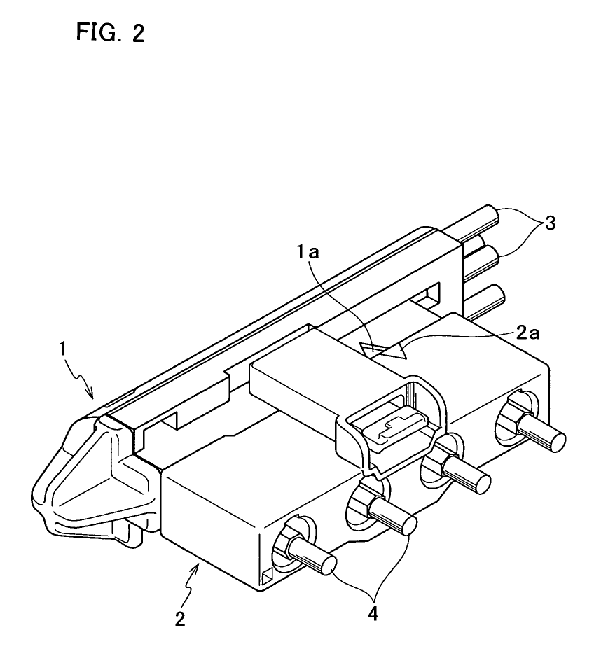

The electrical connecting device 1 is inserted into a roof hole 6 formed in a vehicle roof 5, a part of which is shown in FIG. 1, in the direction of arrow “a,” and is then connected to the to-be-connected housing element 2. As a result, the electric wire 3 and the electric wire 4 are passed through the roof hole 6 between the inside and the outside of the vehicle, and are electrically connected by means of the connectors (1, 2). The electrical connecting device land the to-be-connected housing element 2 are connected as shown in the perspective view of FIG. 2. A triangular mark la is impressed on the electrical connecting device 1 side, and, likewise, a triangular mark 2a is impressed on the to-be-connected housing element 2 side. These marks la and 2a are provided so that their positions coincide with each other when the electrical connecting device 1 and the to-be-connected housing element 2 are properly connected. A confirmation of a proper connection therebetween can be obtained by whether the electrical connecting device 1 and the to-be-connected housing element 2 are connected in a state in which the positions of the marks 1a and 2a coincide with each other.

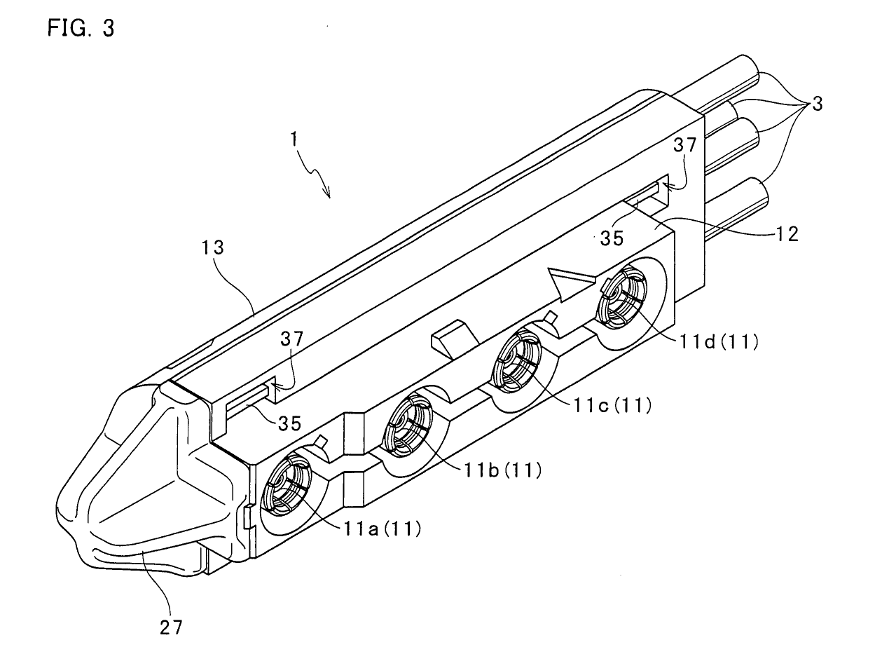

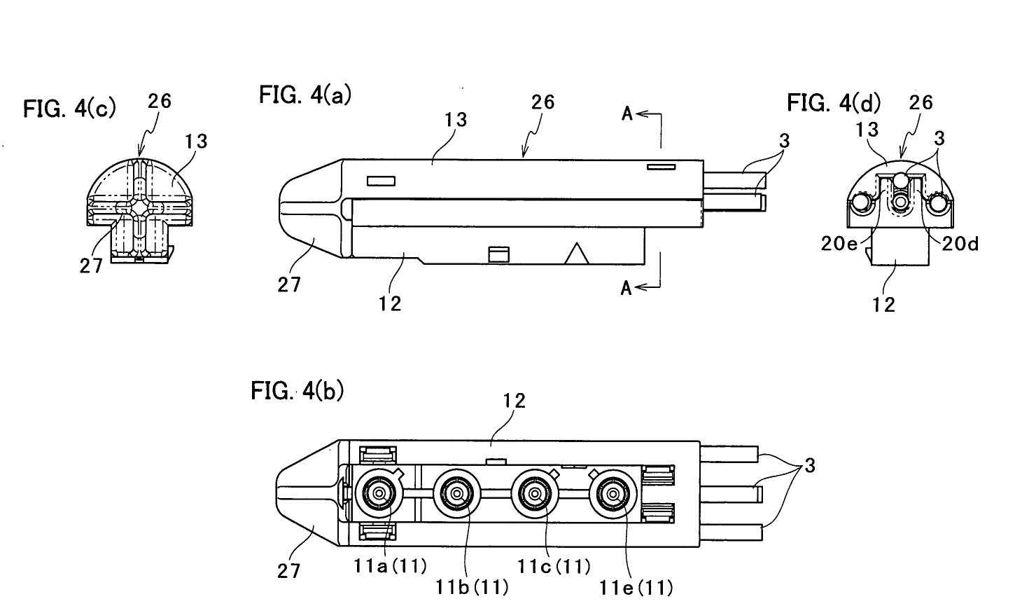

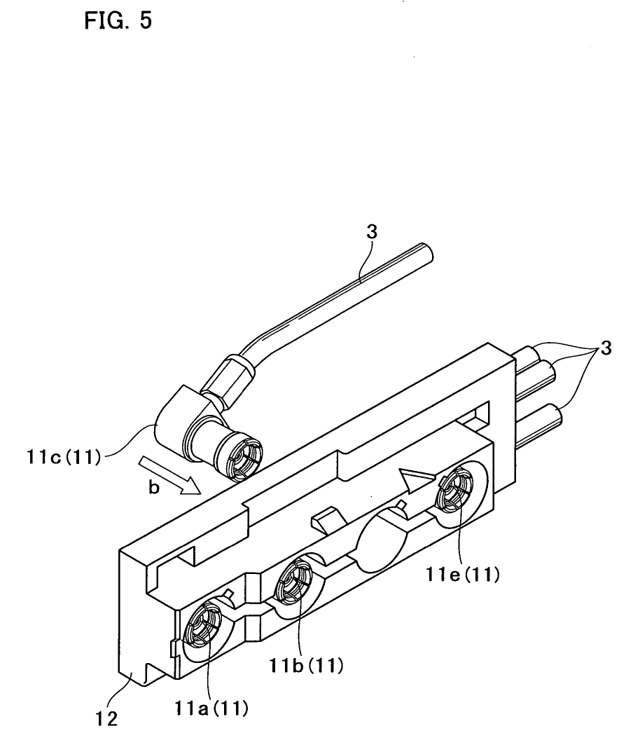

FIG. 3 is a perspective view of the electrical connecting device 1. FIG. 4(a) to FIG. 4(d) are a front view (FIG. 4(a)), a bottom view (FIG. 4(b)), a left side view (FIG. 4(c)), and a right side view of the electrical connecting device 1, respectively. FIG. 5 is an exploded perspective view of a part of the electrical connecting device 1. As shown in FIG. 3 to FIG. 5, the electrical connecting device 1 includes connection terminals 11(11a to 11d) of four poles (four pieces) that are connected to the ends of four electric wires 3, respectively, a connecting housing element 12 that is engaged with and is connected to the to-be-connected housing element 2, and a cover element 13 that is attached to the connecting housing element 12. The connection terminals 11 connected to the electric wires 3 are fitted in the direction of arrow “b” as shown in FIG. 5, and are supported by the connecting housing element 12. The cover element 13 is then fitted to the connecting housing element 12 so as to cover the connection terminals 11 as shown in FIG. 3 and FIG. 4.

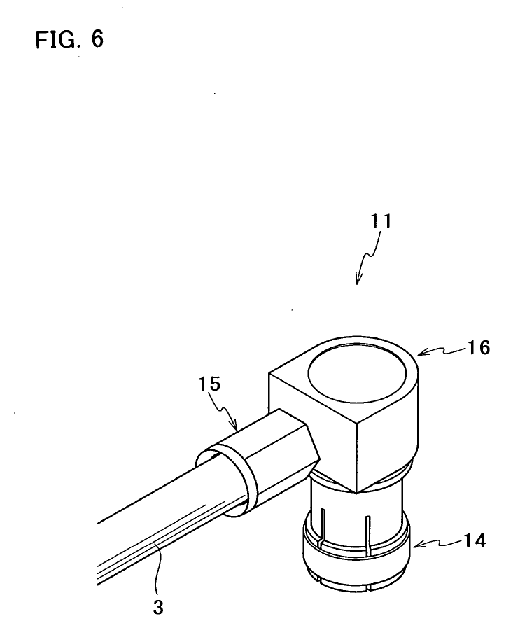

In accordance with a connection between the electrical connecting device 1 and the to-be-connected housing element 2, the connection terminals 11 are electrically connected to to-be-connected terminals, respectively, of the to-be-connected housing element 2. As shown in the perspective view of FIG. 6, the connection terminal 11 has a terminal connection part 14, a wire connection part 15, and a bent part 16. The terminal connection part 14 is brought into contact with and connected to the to-be-connected terminal of the to-be-connected housing element 2. The wire connection part 15 is an end opposite the terminal connection part 14, and is connected to the electric wire 3 in a caulked manner. The bent part 16 is an intermediate part between the terminal connection part 14 and the wire connection part 15, and is bent rectangularly.

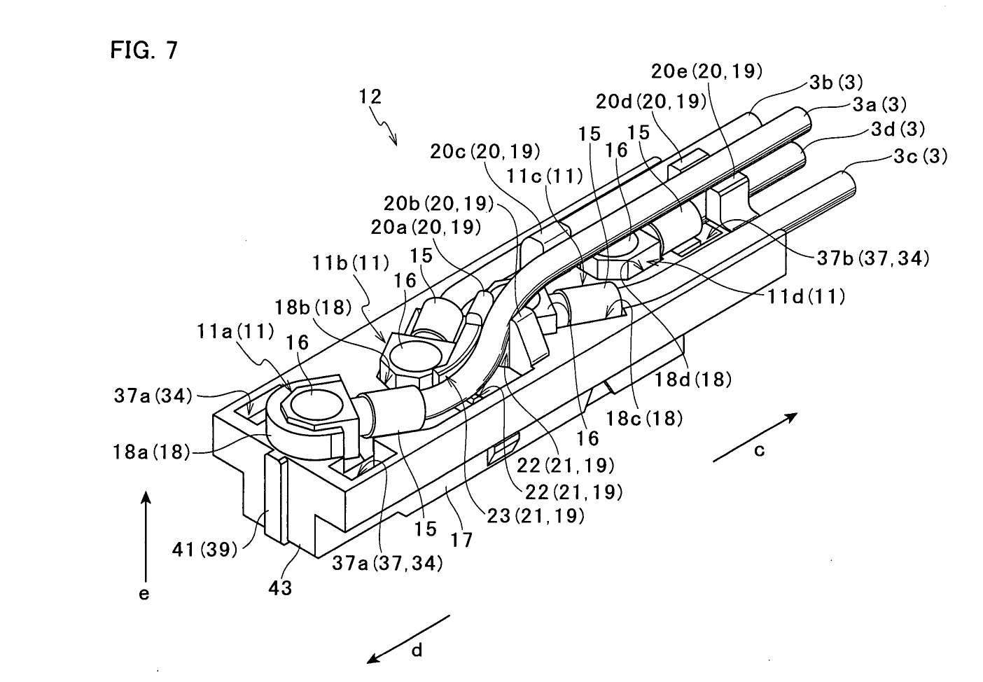

FIG. 7 is a perspective view of the connecting housing element 12, and shows a state in which the connection terminals 11(11a to 11d) of four poles connected to the electric wires 3 (3a to 3d) are attached to the connecting housing element 12. The connecting housing element 12 has a main body 17 shaped like a slender rectangular parallelepiped. Terminal supporting parts 18 and wire supporting parts 19 are formed on the main body 17.

As shown in FIG. 7, the terminal supporting parts 18 (18a to 18d) are provided at four positions so as to support the connection terminals 11 of four poles, respectively. The connection terminal 11a is supported by the terminal supporting part 18a , the connection terminal 11b is supported by the terminal supporting part 18b, the connection terminal 11c is supported by the terminal supporting part 18c, and the connection terminal 11d is supported by the terminal supporting part 18d. The terminal supporting parts 18 are provided to support the connection terminals 11 so that the terminal connection parts 14 of the connection terminals 11 are arranged in a parallel manner in rectilinear form. As shown in FIG. 3 and FIG. 4(b), the terminal connection parts 14 of the connection terminals 11 are supported in the state of being arranged in a parallel manner in rectilinear form on the bottom side of the connecting housing element 12 (i.e., on the side where it is fitted with the to-be-connected housing element 2). Therefore, the connection terminals 11 can be connected to the to-be-connected terminals, 14 respectively, on the side of the to-be-connected housing element 2.

In FIG. 7, each terminal supporting part 18 is formed so that the connection terminal 11 can be held along the periphery of the lower half of the bent part 16. The connection terminal 11d is supported so that the direction in which the wire connection part 15 is arranged becomes parallel to the linear direction in which the terminal connection part 14 is arranged. However, the connection terminals 11a to 11c are supported so that the direction in which the wire connection part 15 is arranged deviates slantingly from the linear direction in which the terminal connection part 14 is arranged. In other words, the front-side connection terminal 11 is supported so that the direction in which the wire connection part 15 of the front-side connection terminal 11 of the adjoining connection terminals 11 and 11, which is disposed on a front side (direction of arrow “d”) opposite a wire leading side (direction of arrow “c”) where the electric wire 3 is led out from the connecting housing element 12, deviates slantingly from the linear direction in which the terminal connection part 14 is arranged.

Herein, the adjoining connection terminals 11 and 11 denote the connection terminals 11a and 11b, the connection terminals 11b and 11c, or the connection terminals 11c and 11d. For example, in a case in which the adjoining connection terminals are the connection terminals 11a and 11b, the front-side connection terminal 11 is the connection terminal 11a, and, in a case in which the adjoining connection terminals are the connection terminals 11c and 11d, the front-side connection terminal 11 is the connection terminal 11c. In this embodiment, one of the adjoining connection terminals 11 and 11 disposed on the wire leading side is referred to as a leading-side connection terminal in the same manner as one of the adjoining connection terminals 11 and 11 disposed on the front side is referred to as a front-side connection terminal 11. That is, in this embodiment, the connection terminals 11a, 11b, and 11c are corresponding to the front-side connection terminal 11, and the connection terminals 11b, 11c, and 11d are corresponding to the leading-side connection terminal 11.

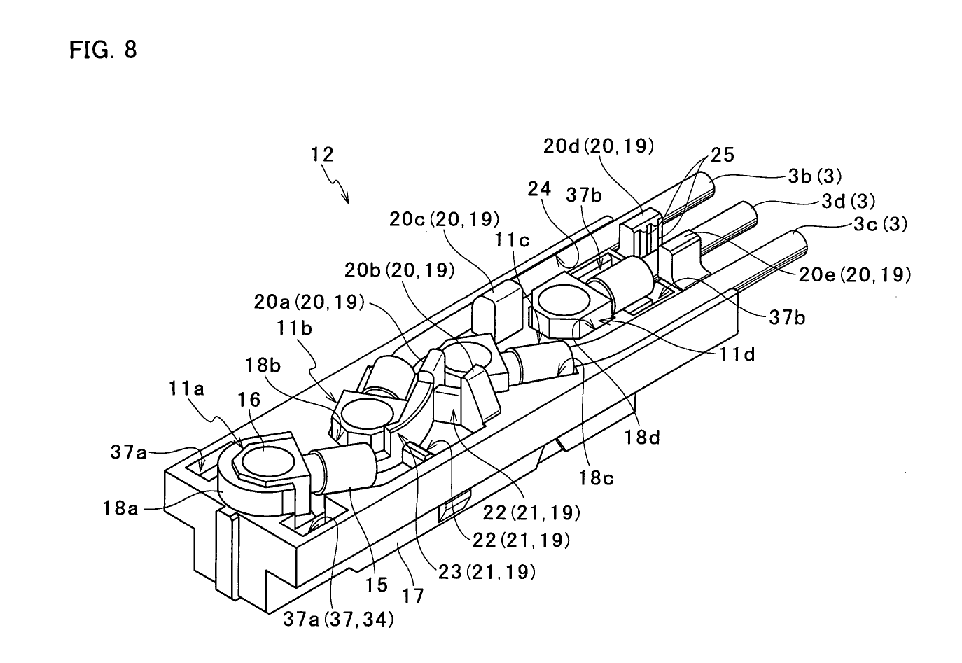

FIG. 8 is a perspective view of the connecting housing element 12 to which the connection terminals 11 (11a to 11d) of four poles have been attached, showing a state in which only the electric wire 3a that is connected to the connection terminal 11a has been removed. As shown in FIG. 7 and FIG. 8, the wire supporting part 19 has a plurality of projection parts 20, a curved supporting part 21, and a fit supporting part 24. Each electric wire 3 is supported by the wire supporting part 19 so that the electric wire 3 is led out in a direction parallel to the linear direction in which the wire connection part 15 of each connection terminal 11 is arranged. The electric wire 3 that is connected to the front-side connection terminal 11 of the mutually adjoining connection terminals 11 and 11 is supported by the wire supporting part 19 so that the electric wire 3 is arranged in such a curved manner as to detour around the periphery of the bent part 16 of the leading-side connection terminal 11 on the wire leading side that is adjacent to the front-side connection terminal 11.

As shown in FIG. 7, in the connecting housing element 12, the projection parts 20 (20a to 20e) protrude toward a non-fit side (i.e., the direction of arrow “e” in FIG. 7) that is opposite the fit side on which the connecting housing element 12 is fitted to the to-be-connected housing element 2. The projection parts 20 are disposed so as to support the electric wire 3a that is connected to the foremost front-side connection terminal 11a. The electric wire 3a is supported by being fitted between a pair of projection parts that face each other in the projection parts 20 (i.e., between the projection parts 20a and 20b, and between the projection parts 20d and 20e). The pair of projection parts 20d and 20e that face each other support the electric wire 3a that is connected to the connection terminal 11a and the electric wire 3d that is connected to the connection terminal 11d such that the electric wire 3a and the electric wire 3d are stacked on each other. That is, the pair of projection parts 20d and 20e serves as a stacking supporting part that supports the electric wires 3a and 3d so that respective cross-sections of parts of the electric wires 3a and 3d supported by the projection parts 20d and 20e are arranged in a stacked manner while being stepped toward the non-fit side.

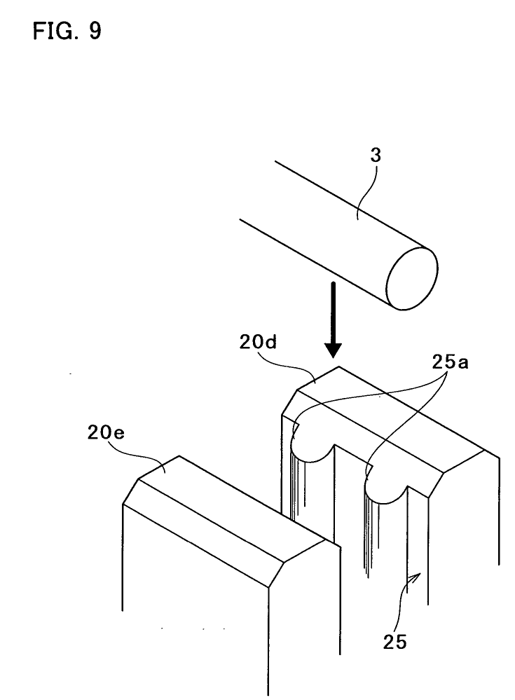

As shown in FIG. 8, on the mutually facing surfaces of the projection parts 20d and 20e serving as a pair, the projection parts 20d and 20e respectively have convexities that protrude toward the electric wires 3a and 3d fitted between the facing surfaces. FIG. 9 is an enlarged perspective view of the projection parts 20d and 20e. As shown in FIG. 9, the projection parts 20d and 20e have the mutually facing surfaces 25 (in FIG. 9, only the facing surface of the projection part 20d is shown), and each of the facing surfaces 25 has two stripes of convex parts 25a, each of which has a semicircular cross-section, on the facing surface. The electric wires 3 are inserted from above the projection parts 20d and 20e toward the projection parts 20d and 20e (i.e., downward as shown by the arrow in FIG. 9), and are thereby fitted between the facing surfaces 25 and 25. The electric wires 3 fitted therebetween are supported while being clamped by the convex parts 25a between the facing surfaces 25 and 25 from both sides.

The curved supporting part 21 supports the electric wire 3a that is connected to the front-side connection terminal 11a such that the electric wire 3a is disposed in such a curved manner as to detour the periphery of the bent part 16 of the leading-side connection terminal 11b while being displaced toward the non-fit side. As shown in FIG. 8, the curved supporting part 21 is formed of a step part 22 and a curved wall part 23. The step part 22 protrudes from the connecting housing element 2 toward the non-fit side so that the height thereof on the non-fit side becomes greater step by step, and is formed like stairs having a plurality of steps. The curved wall part 23 protrudes toward the non-fit side, and a portion of the curved wall part 23 being in contact with the electric wire 3a is curved. In this electrical connecting device 1, the electric wire 3a, which is the upper one of the electric wires 3a and 3d stacked between the projection parts 20d and 20e serving as the stacking supporting part, is disposed in such a curved manner as to detour the periphery of the bent part 16 of the leading-side connection terminal 11b while being displaced toward the non-fit side (see FIG. 7).

The fit supporting part 24 is hollowed like a groove, and, as shown in FIG. 8, the electric wire 3b, which is connected to the connection terminal 11b, and the electric wire 3c, which is connected to the connection terminal 11c, are fitted into and supported by the fit supporting part 24. The electric wires 3b and 3c are supported by the supporting part 24 in such a way as to be led out in a direction parallel to the linear direction of the terminal connection part 14, and are curved in such a way as to detour the periphery of the bent part 16 of each of the leading-side connection terminals 11c and 11d.

As mentioned above, in the connecting housing element 12, the position of each electric wire 3 can be fixed by the wire supporting part 19. Fluctuations in radio interference characteristics between the electric wires 3 (i.e., fluctuations in radio interference characteristics as a unit of the electrical connecting device 1 which is a product) can be controlled by fixing the position of the electric wire 3. Additionally, since the electric wires 3a to 3c that are connected to the front-side connection terminals 11a to 11c are arranged in such a curved manner as to detour the peripheries of the leading-side connection terminals 11b to 11d, the electric wires 3a to 3c can be prevented from being bent. Especially, a coaxial electric wire for high frequencies easily causes performance degradation (VSWR) when bent, and hence the occurrence of such performance degradation can be prevented.

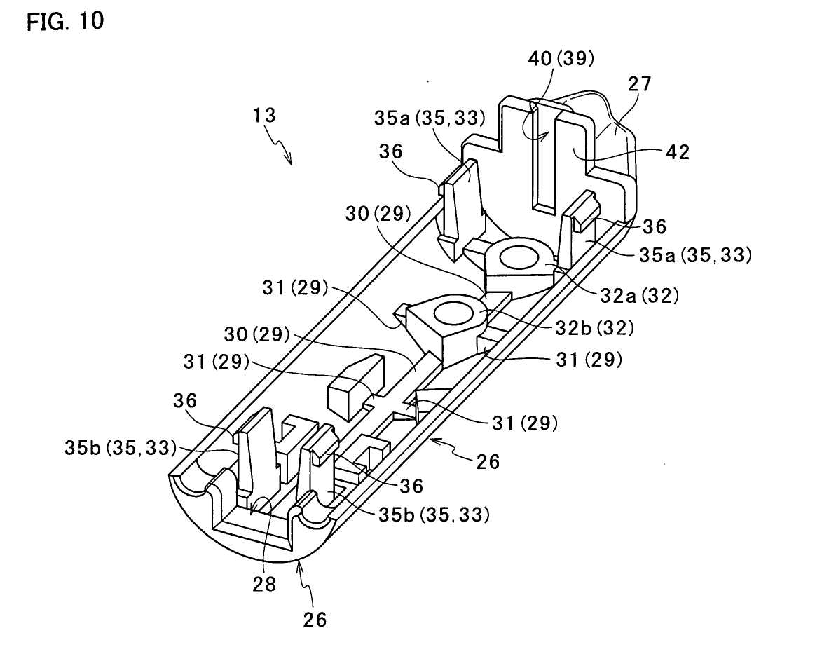

FIG. 10 is a perspective view of the cover element 13, in which a side of the cover element 13 that is connected to the connecting housing element 12 is directed upward. The cover element 13 is attached to the connecting housing element 12 so as to cover the connection terminals 11 (see FIG. 3). As shown in FIG. 4 and FIG. 10, the cover element 13 has an arcuate dome part 26 in a cross-section perpendicular to the direction in which the electric wire 3 is disposed in a parallel manner by means of the wire supporting part 19 of the connecting housing element 12. The electric wires 3 are arranged in a stacked manner in the connecting housing element 12, and are crowded inside the dome part 26 by attaching the cover element 13 to the connecting housing element 12.

As shown in FIG. 3, FIG. 4(a) to FIG. 4(d), and FIG. 10, the cover element 13 has an extreme part 27, which is an end on the extreme side (i.e., front side), tapered toward its tip. The cover element 13 is formed so that an extreme part of the connecting housing element 12 to which the cover element 13 is attached is covered with the extreme part 27 of the cover element 13. Since the extreme part 27 is tapered toward its tip, the cover element 13 can be inserted into the roof hole 6 smoothly and easily. Additionally, the extreme part 27 is formed so that its cross-section perpendicular to the direction toward its tip exhibits point symmetry and line symmetry. More specifically, the cross-section of the extreme part 27 is shaped like a cross. Since the cross-section of the extreme part 27 is formed to exhibit at least either point symmetry or line symmetry, the tapered extreme part 27 can have sufficient strength against an impact acting in a bent direction, and, the extreme part 27 can be prevented from being damaged even if the extreme part 27 is impacted by coming into collision with the edge of the roof hole 6 when the extreme part 27 is inserted into the roof hole 6.

The cover element 13 has a difference in shape between one end of the cover element 13 on the wire leading side where the electric wire 3 is led out and the other end thereof opposite the wire leading side. Therefore, the direction in which the cover element 13 is attached to the connecting housing element 12 can be restricted to a single direction. As a result, erroneous connecting operations can be prevented when the electrical connecting device 1 is assembled. An opening part 28 that is engaged with the pair of projection parts 20d and 20e of the connecting housing element 12 is formed at the end on the wire leading side of the cover element 13 (see FIG. 4(d) and FIG. 10).

As shown in FIG. 10, the cover element 13 has a reinforcement part 29 formed by partially thickening the dome part 26. The reinforcement part 29 is formed of a first reinforcement part 30 and a second reinforcement part 31. The first reinforcement part 30 is formed inside the dome part 26, and serves as a rib that protrudes toward the connecting housing element 12 to which the cover element 13 is attached. The first reinforcement part 30 is linearly formed in a direction parallel to the linear direction in which the terminal connection part 14 is arranged in the connecting housing element 12 to which the cover element 13 is attached. That is, the rib forming the first reinforcement part 30 is linearly extended in the longitudinal direction of the cover element 13.

The second reinforcement part 31 is also formed inside the dome part 26, and serves as a rib that protrudes toward the connecting housing element 12 to which the cover element 13 is attached in the same manner as the first reinforcement part 30. The second reinforcement part 31 is formed so as to be disposed along a cross-section of the dome part 26 perpendicular to the linear direction in which the terminal connection part 14 is arranged in the connecting housing element 12 to which the cover element 13 is attached (i.e., along a cross-section perpendicular to the longitudinal direction of the cover element 13 in the dome part 26). The second reinforcement part 31 is intersected with the first reinforcement part 30, and is formed integrally with the first reinforcement part 30 at the intersection of the first and second reinforcement parts 30 and 31. Thus, the reinforcement part 29 is disposed so as to function as a framework by which the shape of the cover element 13 is easily maintained.

The cover element 13 additionally has regulating parts 32 (32a and 32b) that regulate the movement of the connection terminals 11 toward the cover element 13 between the cover element 13 and the connecting housing element 12 when the cover element 13 is attached to the connecting housing element 12. The regulating parts 32 protrude from the dome part 26 at a plurality of positions, respectively. The regulating part 32a regulates the movement of the connection terminal 11a by coming into contact with the connection terminal 11a, and the regulating part 32b regulates the movement of the connection terminal 11b by coming into contact with the connection terminal 11b. The regulating parts 32 (32a and 32b) are formed integrally with the dome part 26 and are united with each other with the reinforcement part 29 (the first reinforcement part 30) therebetween. Since the regulating parts 29 are provided in this manner, the position of the connection terminal 11 can be fixed in the fitting direction when the cover element 13 is attached, and the connection terminal 11 can be prevented from being supported in an improper state (i.e., in a state of being incompletely inserted).

Thus, in the cover element 13, a space inside the dome part 26 can be effectively utilized, and the dome part 26 can be provided with the partially thickened reinforcement part 29 at a position where interference never occurs with the connection terminals 11 and the electric wires 3 disposed inside the dome part 26. Therefore, the strength of the dome part 26 can be increased without obstruction to the size reduction of the cover element 13. Additionally, since the cover element 13 has the rib, which serves as the first reinforcement part 30, linearly formed in the longitudinal direction of the cover element 13, the bending strength with respect to the longitudinal direction of the cover element 13 can be increased. Additionally, since the cover element 13 has the rib, which serves as the second reinforcement part 31, disposed along the cross-section of the dome part 26 perpendicular to the longitudinal direction of the cover element 13, the torsional strength with respect to the longitudinal direction of the cover element 13 can be increased. Additionally, since the cover element 13 has the regulating parts 32 united with each other with the reinforcement part 29 (first reinforcement part 30) therebetween, the regulating parts 32 can be effectively utilized as a part of the reinforcement part 30.

As shown in FIG. 10, a cover-side engagement part 33 is provided inside the cover element 13. On the other hand, as shown in FIG. 7, a housing-side engagement part 34 is provided on the side opposite the inside of the cover element 13 in the connecting housing element 12 to which the cover element 13 is attached. The cover-side engagement part 33 and the housing-side engagement part 34 are formed so as to be engaged with each other, and hence a locking mechanism is formed when the cover element 13 is attached to the connecting housing element 12.

As shown in FIG. 10, the cover-side engagement part 33 has engagement protrusion parts 35 (35a, 35b) and engagement convex parts 36. Inside the cover element 13, the engagement protrusion part 35 protrudes toward the connecting housing element 12 to which the cover element 13 is attached. A pair of engagement protrusion parts 35a and 35a are provided on the extreme side of the cover element 13, and a pair of engagement protrusion parts 35b and 35b are provided on the wire leading side of the cover element 13. At the tip of each engagement protrusion part 35, the engagement convex part 36 further protrudes from each engagement protrusion part 35 outward (i.e., toward a side opposite the side where the pair of engagement protrusion parts 35a and 35a or 35b and 35b face each other).

The housing-side engagement part 34 has hole parts 37 (37a, 37b) and engagement concave parts 38. As shown in FIG. 7 and FIG. 8, the hole part 37 is formed of a pair of hole parts 37a and 37a provided on the extreme side and a pair of hole parts 37b and 37b provided on the wire leading side. Each hole part 37 serves as a through-hole into which each engagement protrusion part 35 of the cover element 13 is fitted. The pair of engagement protrusion parts 35a and 35a are fitted into the pair of hole parts 37a and 37a, respectively, whereas the pair of engagement protrusion parts 35b and 35b are fitted into the pair of hole parts 37b and 37b, respectively.

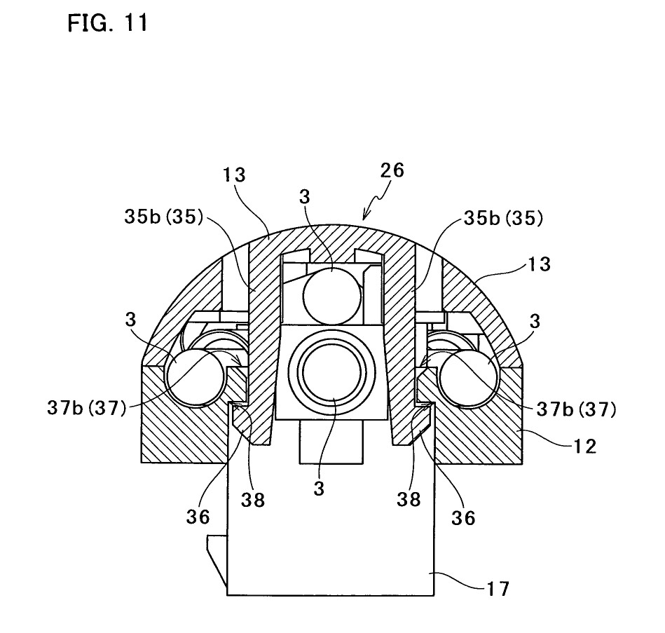

The engagement concave part 38 has a hollow corresponding to each hole part 37. FIG. 11 is a cross-sectional view along line A-A of FIG. 4 (in which the cross-section of the electric wire 3 is not shown). As shown in FIG. 11, each engagement concave part 38 is hollowed so as to be engaged with each engagement convex part 36 in a state in which the engagement protrusion part 35 is fitted to the hole part 37. When the cover element 13 is attached to the connecting housing element 12, and then the engagement protrusion part 35 is fitted into the hole part 37, the engagement convex part 36 at the top of the engagement protrusion part 35 first interferes with the edge of the hole part 37. The engagement convex part 36proceeds into the hole part 37 while the engagement protrusion part 35 is being bent toward the inside by this interference. When the engagement convex part 36 reaches the position facing the engagement concave part 38, the engagement convex part 36 and the engagement concave part 38 are engaged with each other, and the cover element 13 is reliably held (locked) in the connecting housing element 12.

As shown in FIG. 3, the engagement protrusion part 35 of the cover element 13 has a length not to protrude from the hole part 37 of the connecting housing element 12. The engagement protrusion part 35 protrudes inside the dome part 13 in this manner, and neither appears from the side face of the connecting housing element 12 nor protrudes from the hole part 37 when the cover element 13 is attached to the connecting housing element 12. Therefore, when the cover element 13 is attached to the connecting housing element 12, the engagement protrusion part 35 can be prevented from interfering with an external member and being damaged (for example, when the electrical connecting device 1 is inserted into the roof hole 6, the engagement protrusion part 35 can be prevented from interfering with the edge of the roof hole 6 and being damaged).

As shown in FIG. 7 and FIG. 10, each of the cover element 13 and the connecting housing element 12 has a positioning part 39 on the extreme side by which the cover element 13 and the connecting housing element 12 are engaged and positioned. The positioning part 39 is formed of a groove part (first groove part) 40 formed in the cover element 13 and a stripe part (second stripe part) 41 that is formed on the connecting housing element 12 and that is engaged with the groove part 40. The groove part 40 on the side of the cover element 13 is formed on the backface of a wall provided to support the extreme part 27, i.e., on a first sliding surface 42 that is slid and put onto the end of the connecting housing element 12 of the extreme part 21. The groove part 40 is linearly hollowed. On the other hand, the stripe part 41 on the side of the connecting housing element 12 is formed on an end face on the extreme side, i.e., on a second sliding surface 43 that is slid onto the first sliding surface 42 of the cover element 13 on the extreme side of the connecting housing element 12. The stripe part 41 is linearly ridged so as to be engaged with the groove part 40.

Since the positioning part 39 is formed in this manner, the cover element 13 can be attached to the connecting housing element 12 so that the groove part 40 and the stripe part 41 are engaged with each other while being slid onto each other. Therefore, the extreme side of the cover element 13 can be easily subjected to proper positioning with respect to the connecting housing element 12 when the cover element 13 is attached to the connecting housing element 12. Additionally, the cover element 13 can be prevented from being improperly attached to the connecting housing element 12 while being deviated in the width direction. Additionally, since the cover element 13 is attached to the connecting housing element 12 while the groove part 40 and the stripe part 41, which are linearly formed with a long length, are being fitted to each other, the cover element 13 can be prevented from being rotated in the torsional direction with respect to the longitudinal direction during the attaching operation, and can be prevented from being damaged by its rotation.

According to the electrical connecting device 1 described above, the connection terminal 11 has the bent part 16 formed between the terminal connection part 14 and the wire connection part 15, and the electric wire 3 connected to the wire connection part 15 is led out in a direction parallel to the linear direction in which the terminal connection part 14 is arranged. Additionally, the electric wire 3 connected to the front-side connection terminal 11 is disposed in such a curved manner as to detour the periphery of the bent part 16 of the leading-side connection terminal 11. Therefore, the electric wires 3 can be bundled in the parallel direction, and can be effectively crowded without interference with the leading-side connection terminal 11, thus making it possible to integrate a space to dispose the electric wires 3. In other words, great restrictions can be imposed on the fact that the electrical connecting device becomes large depending on the pitch where the terminal connection parts 14 are arranged in parallel, and, accordingly, the electrical connecting device can be reduced in size.

This is advantageous in performing operations in a limited space like a narrow space or in performing a connecting operation through such a space. Since the electrical connecting device 1 is slender in the linear direction in which the terminal connection parts 14 are arranged, a great advantage can be obtained especially when a hole in the wall surface is connected to another member after the electrical connecting device 1 is passed therethrough. In other words, the size of the hole can be reduced, and the electrical connecting device can be easily passed therethrough.

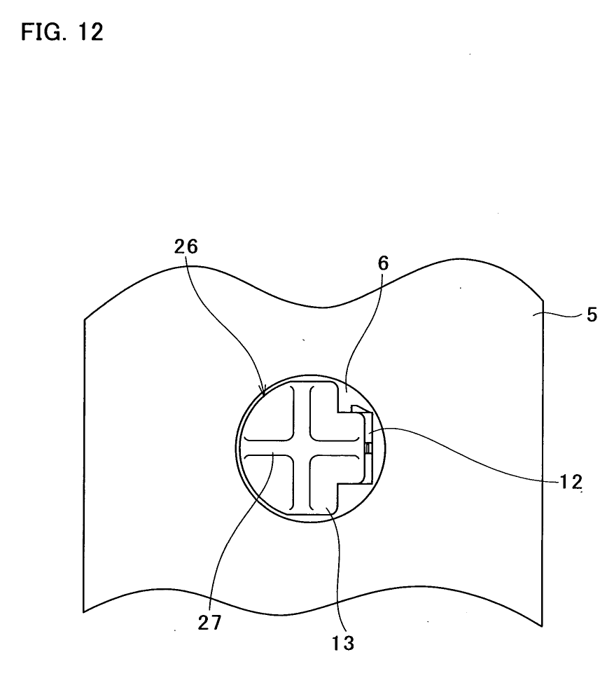

FIG. 12 shows the electrical connecting device 1 viewed from its front side in a state in which the electrical connecting device 1 already assembled is inserted in the roof hole 6. Since the electrical connecting device 1 can be made slender and compact and since a cross-sectional area of the electrical connecting device 1 can be reduced in a direction in which the electrical connecting device 1 is passed through the roof hole 6, the electrical connecting device 1 can be smoothly passed through the roof hole 6 small in the opening area as shown in FIG. 12. Additionally, since the cover element 13 has the dome part 26, a part of the outer periphery of the electrical connecting device 1 can be outlined so as to meet the inner periphery of the circular roof hole 6, and the electrical connecting device 1 never interferes with the edge of the roof hole 6. Therefore, the electrical connecting device can be reduced in size.

Additionally, according to the electrical connecting device 1, the electric wires 3 can be efficiently gathered together without interference between the electric wires 3 connected to the front-side connection terminals 11 and the leading-side connection terminals 11. Therefore, it is possible to ease dimensional restrictions on the arrangement of the front-side connection terminals 11 and the leading-side connection terminals 11 that adjoin each other. That is, since an interval between the front-side connection terminal 11 and the leading-side connection terminal 11 can be shortened, a size reduction in the longitudinal direction can be achieved, and the design freedom of the wire connection part 15 of the front-side connection terminal 11 can be increased, and it is possible to ease the fact that the electric wire 3 connected to the wire connection part 15 of the front-side connection terminal 11 is bent.

Therefore, it is possible to ease a disadvantage resulting from dimensional restrictions on a connection between the to-be-connected housing element that supports the to-be-connected terminals of four or more poles arranged in a parallel manner in rectilinear form and the electrical connecting device that has the connecting housing element supporting the connection terminals of four or more poles that are electrically connected to the to-be-connected terminals, respectively. Therefore, the electrical connecting device can be reduced in size.

Additionally, since the bent part 16 is bent at a right angle in the electrical connecting device 1, it is possible to diminish the distance between the straight line along which the terminal connection part 14 is arranged in a parallel manner and the electric wire 3 that is connected to the wire connection part 15 and that is arranged in parallel with the straight line. That is, a slender shape extending in the direction in which the terminal connection part 14 is arranged can be formed, and the electrical connecting device can be made more compact.

Additionally, since the orientation direction of the wire connection part 15 is deviated obliquely with respect to the linear arrangement direction of the terminal connection part 14 in the electrical connecting device 1, a space in the width direction can be effectively utilized in the electrical connecting device 1, and the electric wires 3 can be more efficiently gathered without interference between the electric wires 3 connected to the front-side connection terminals 11 and the leading-side connection terminals 11.

Additionally, in the electrical connecting device 1, the electric wires 3 connected to the front-side connection terminals 11 are disposed in such a curved manner as to detour the periphery of the leading-side connection terminal 11 while shifting the position thereof toward the non-fit side. Therefore, interference can be avoided between the electric wires 3 connected to the front-side connection terminals 11 and the leading-side connection terminals 11, and the electric wires 3 can be efficiently gathered even in a space on the non-fit side for the electric wires 3 connected to the leading-side connection terminals 11. Therefore, it is possible to achieve a greater reduction of dimensional restrictions on the arrangement of the front-side connection terminal 11 and the leading-side connection terminal 11 that adjoin each other.

Additionally, since the electric wires 3 that are connected to the wire connection parts 15 and that are arranged in a parallel manner can be disposed so as to stack the cross-sections thereof in the electrical connecting device 1, the electric wires 3 can be more densely bundled in the parallel direction. Since the upper one of the electric wires 3 stacked thereon is disposed in such a curved manner as to detour the periphery of the leading-side connection terminal 11 while shifting its position toward the non-fit side, the electric wires 3 can be efficiently gathered without interference between the electric wires 3 connected to the front-side connection terminals 11 and the leading-side connection terminals 11 when the upper electric wire 3 is disposed in such a manner as to be drawn around.

Additionally, the curved supporting part 21 is formed as the wire supporting part 19 in the electrical connecting device 1, and therefore, when the electric wire 3 connected to the front-side connection terminal 11 is disposed in such a curved manner as to detour the periphery of the leading-side connection terminal 11 while shifting its position toward the non-fit side, the electric wire 3 connected to the front-side connection terminal 11 can be stably supported without being moved.

Additionally, since a step part 22 having a plurality of steps that become higher step by step is provided as the curved supporting part 21 in the electrical connecting device 1, the electric wire 3 can be disposed while smoothly shifting its position toward the non-fit side. Additionally, the curved supporting part 21 can be easily formed by a simple structure that the step part 22 having a plurality of steps is provided.

Additionally, since the curved wall part 23 is formed as the curved supporting part 21 in the electrical connecting device 1, the disposition of the electric wire 3 connected to the front-side connection terminal 11 along the curved wall part 23 makes it possible to dispose the electric wire 3 in such a smoothly curved manner as to detour the periphery of the leading-side connection terminal 11 while shifting its position toward the non-fit side. Additionally, the electric wire 3 that is disposed in a curved manner can be stably supported not to be moved.

Additionally, in the electrical connecting device 1, the electric wires 3 can be supported merely by providing a plurality of projection parts 20 on the connecting housing element 12 and by fitting the electric wires 3 between the pair of projection parts 20 and 20 that face each other. Therefore, the wire supporting part 19 can be easily formed. Additionally, since the convex parts 25a are formed on each facing surface 25 between the projection parts 20 and 20, the electric wire 3 fitted between the projection parts 20 and 20 can be stably supported by the convex part 25a. Additionally, since the convex part 25a has a semicircular cross-section, the electric wires 3 can be supported by the mutually closest parts between the convex parts 25a and 25a nearly in a line contact state, and the electric wires 3 can be held with a greater force. Additionally, since the convex part 25a is semicircular in cross-section, the electric wires 3 can be prevented from being flawed by the convex part 25a.

Additionally, in the electrical connecting device 1, the cover-side engagement part 33 is provided inside the cover element 13, and the housing-side engagement part 34 is provided on the side opposite the inside of the cover element 13. Therefore, when the cover-side engagement part 33 and the housing-side engagement part 34 are engaged with each other, and then the cover element 13 is attached to the connecting housing element 12, neither the cover-side engagement part 33 nor the housing-side engagement part 34 can be exposed outward. Therefore, a mechanism to make an engagement between the cover element 13 and the connecting housing element 12 can be prevented from interfering with an external member and from being damaged. Additionally, the provision of the engagement protrusion part 35 having the engagement convex part 36 inside the cover element 13 and the formation of the hole part 37 having the engagement concave part 38 in the connecting housing element 12 make it possible to easily form the mechanism to make an engagement between the cover element 13 and the connecting housing element 12 so as to have a simple structure without being exposed outward.

Additionally, in the electrical connecting device 1, in order to attach the cover element 13 to the connecting housing element 12, the positioning part 39 formed on the extreme side is first engaged, whereby the cover element 13 and the connecting housing element 12 can be easily positioned. Therefore, the cover element 13 can be promptly attached without a positional disagreement between the connecting housing element 12 and the cover element 13. Additionally, since positioning can be performed at once when the cover element 13 is attached to the connecting housing element 12, the cover element 13 can be prevented from being improperly attached to the connecting housing element 12 by mistake. Additionally, the occurrence of damage or the like resulting from the incorrect attachment in a deviated position can be prevented. Additionally, since the positioning part 39 is formed of the groove part 40 and the stripe part 41 that are engaged with each other, the positioning of the cover element 13 and the connecting housing element 12 by using the positioning part 39 makes it possible to prevent the cover element 13 from being attached in a state of being twisted with respect to the connecting housing element 12.

The embodiment of the present invention has been described as above. However, as a matter of course, the present invention is intended to embrace all modifications, variations, and their equivalents that fall within the spirit and scope of the appended claims, and such modifications and variations will become apparent by reading and understanding this specification.

For example, the following modifications may be carried out.

In the above embodiment, a description was given of the electrical connecting device that is first inserted into the roof hole, and is then connected to the to-be-connected housing element. However, the present invention can also be applied to a hole formed at a place other than the roof hole. Likewise, the present invention can be applied in a case in which the electrical connecting device is inserted into a hole other than that of a vehicle. Additionally, without being limited to a case in which the electrical connecting device is inserted into such a hole, the present invention can be applied in a case in which connecting operations are performed in a limited space like a narrow space.

In the above embodiment, a description was given of the electrical connecting device used for coaxial electric wires. However, the present invention can be applied to electric wires that are not coaxial.

In the above embodiment, a description was given of a case in which the bent part of the connection terminal is formed at a right angle. However, the present invention is not limited to such a rectangularly bent part. For example, the bent part may be formed to be a two-stage bent part having each stage bent at an angle of about 45 degrees.

The shape of the wire supporting part and the shape of the terminal supporting part provided on the connecting housing element are not limited to those of the above embodiment. That is, the shape of the terminal supporting part is not limited to the aforementioned one as long as the terminal connection parts are arranged in a parallel manner in rectilinear form so as to be connected to the to-be-connected terminals. The shape of the wire supporting part is not limited to the aforementioned one as long as the electric wires are supported so as to be led out in a direction parallel to the linear direction in which the terminal connection parts are arranged, and as long as the electric wires connected to the front-side connection terminals are supported in such a curved manner as to detour the periphery of the leading-side connection terminal.

In the above embodiment, a description was given of the electrical connecting device connected to the connecting housing element that supports the to-be-connected terminals of four poles. However, the present invention can be applied to to-be-connected terminals of five or more poles.

In the above embodiment, a description was given of a case in which the curved supporting part is formed of a step part having a plurality of steps and a curved wall part. However, the present invention is not limited to this. For example, the curved supporting part may have only a step part having a plurality of steps without having a curved wall part. Additionally, the curved supporting part may be formed of a slope part that has a slant surface ascending toward the non-fit side, without such a step part having a plurality of steps. In this case, the formation of such a slope part having a slant surface ascending toward the non-fit side makes it possible to arrange the electric wires while smoothly shifting their positions toward the non-fit side. Additionally, the curved supporting part can be easily formed by a simple structure having such a slope part.

In the above embodiment, a description was given of a case in which the positioning part is formed on the cover element and on the extreme side of the connecting housing element. However, the present invention is not limited to this. For example, the positioning part may be provided only on the wire leading side, or may be provided both on the extreme side and on the wire leading side. In the above embodiment, a description was given of a case in which the groove part is provided on the cover element side, and the stripe part is provided on the connecting housing element side. However, these may be provided in a reverse manner. That is, the stripe part may be provided on the cover element side, and the groove part may be provided on the connecting housing element side. Alternatively, a plurality of stripe parts may be provided on the cover element side, and a plurality of groove parts may be provided on the connecting housing element side.

### INDUSTRIAL APPLICABILITY

As is clear from the above description, the electrical connecting device according to the present invention is applicable particularly to a case in which the electrical connecting device is used in such a way as to be first inserted into a hole formed to insert electric wires between the inside and outside of a vehicle and be then connected to a to-be-connected housing element. However, broader applications, in addition to this application, are possible for the present invention, and the present invention can be applied in a number of different environments and for a variety of purposes.

What is claimed is:

1. An electrical connecting device that is connected to a to-be-connected housing element that supports to-be-connected terminals of four or more poles arranged in a parallel manner in rectilinear form, the electrical connecting device comprising:
connection terminals of four or more poles that are electrically connected to the to-be-connected terminals, respectively, and
a connecting housing element that is connected to the to-be-connected housing element by an engagement therebetween,
each of the connection terminals having:
a terminal connection part that is connected to the to-be-connected terminal;
a wire connection part that is an end on a side opposite the terminal connection part and that is connected to an electric wire; and
a bent part bent between the terminal connection part and the wire connection part,
the connecting housing element having:
a terminal supporting part that supports each of the connection terminals so that the terminal connection parts are arranged in a parallel manner in rectilinear form and are connected to the to-be-connected terminals, respectively; and
a wire supporting part that supports each of the electric wires so that the electric wires connected to the wire connection parts are led out in a direction parallel to a linear arrangement direction in which the terminal connection parts are arranged,
wherein the wire supporting part supports the electric wire so that the electric wire connected to a front-side connection terminal, which is one of the connection terminals adjacent to each other, disposed on an extreme side opposite a wire leading side where the electric wire is led out from the connecting housing element can be arranged in such a curved manner as to detour a periphery of the bent part of the leading-side connection terminal that is the connection terminal adjacent to the front-side connection terminal on the wire leading side.

2. The electrical connecting device of claim 1, wherein the bent part is bent at a right angle.

3. The electrical connecting device of claim 1, wherein the terminal supporting part supports the front-side connection terminal so that an orientation direction of the wire connection part of the front-side connection terminal deviates obliquely from the linear arrangement direction of the terminal connection part.

4. The electrical connecting device of claim 1, wherein the electric wire that is connected to at least one of the front-side connection terminals is supported to be arranged in such a curved manner as to detour the periphery of the bent part of the leading-side connection terminal while shifting a position thereof toward a non-fit side opposite a side where the electrical connecting device is fitted to the to-be-connected housing element in the connecting housing element.

5. The electrical connecting device of claim 4, wherein the wire supporting part further has a stacking supporting part that supports each electric wire so that a cross-section of a portion supported by the wire supporting part of each electric wire connected to the wire connection part is arranged in a stacked manner as an upper one toward the non-fit side, and the electric wire disposed as an upper one at the stacking supporting part is arranged in such a curved manner as to detour the periphery of the bent part of the leading-side connection terminal while shifting a position thereof toward the non-fit side.

6. The electrical connecting device of claim 4, wherein the wire supporting part further has a curved supporting part that supports the electric wire connected to at least one of the front-side connection terminals so as to be arranged in such a curved manner as to detour the periphery of the bent part of the leading-side connection terminal while shifting a position thereof toward the non-fit side.

7. The electrical connecting device of claim 6, wherein the curved supporting part further has a step part having a plurality of steps protruding from the connecting housing element toward the non-fit side so that the steps become higher step by step toward the non-fit side.

8. The electrical connecting device of claim 6, wherein the curved supporting part further has a slope part having a slant surface ascending toward the non-fit side.

9. The electrical connecting device of claim 6, wherein the curved supporting part further has a curved wall part that protrudes toward the non-fit side and that has a curved surface portion being in contact with the electric wire.

10. The electrical connecting device of claim 4, wherein the wire supporting part further has a plurality of projection parts that protrude toward the non-fit side in the connecting housing element and
that support the electric wire by fitting the electric wire between a pair of the projection parts that face each other, the wire supporting part further having convex parts on mutually facing surfaces of the pair of projection parts, respectively, the convex parts protruding toward the electric wire fitted between the mutually facing surfaces.

11. The electrical connecting device of claim 10, wherein the convex part is semicircular in cross-section.

12. The electrical connecting device of claim 1, further comprising a cover element that is attached to the connecting housing element so as to cover the connection terminals, wherein
the cover element has a cover-side engagement part inside the cover element, and the connecting housing element to which the cover element is attached has a housing-side engagement part on a side facing the inside of the cover element, the cover-side engagement part and the housing-side engagement part being engaged with each other.

13. The electrical connecting device of claim 12, wherein the cover-side engagement part has an engagement protrusion part that protrudes toward the connecting housing element to which the cover element is attached inside the cover element and an engagement convex part that further protrudes from the engagement protrusion part, whereas
the housing-side engagement part has a hole part that has an engagement concave part hollowed so as to be engaged with the engagement convex part and into which the engagement protrusion part is fitted.

14. The electrical connecting device of claim 1, further comprising a cover element that is attached to the connecting housing element so as to cover the connection terminals, wherein
the cover element and the connecting housing element have positioning parts, respectively, for positioning by being engaged with each other at least either on the extreme side or on the wire leading side.

15. The electrical connecting device of claim 14, wherein the positioning part includes a first stripe part or a first groove part provided on the cover element and a second groove part that is engaged with the first stripe part or a second stripe part that is engaged with the first groove part, the second groove part and the second stripe part being provided on the connecting housing element.

16. The electrical connecting device of claim 15, wherein a front part of the cover element on the extreme side is tapered toward the extreme side, and is formed to cover the extreme side of the connecting housing element to which the cover element is attached, and,
in the cover element, the first stripe part or the first groove part is formed on a first sliding surface to be covered while being slid onto the extreme side of the connecting housing element of the extreme part, whereas,
in the connecting housing element, the second groove part or the second stripe part is formed on a second sliding surface that is slid onto the first sliding surface on the extreme side of the connecting housing element.

17. The electrical connecting device of claim 1, the electrical connecting device being used as an electrical connecting device that is first inserted into a hole formed to insert the electric wires between the inside and outside of a vehicle, and is then connected to the to-be-connected housing element.
